(19) United States
(12) Patent Application Publication
(10) Pub. No.: US 2026/0320629 A1
(43) Pub. Date: Oct. 15, 2026

(54) SYSTEM AND PROCESS FOR DIGITAL LABEL AND COMPLIANCE AUTHENTICATION

(71) Applicant: SMARTag, LLC, Corvallis, OR (US)

(72) Inventor: Lucas Solis, West Linn, OR (US)

(21) Appl. No.: 19/465,463

(22) Filed: Jan. 30, 2026

Related U.S. Application Data
(63) Continuation-in-part of application No. 19/013,823, filed on Jan. 8, 2025.
(60) Provisional application No. 63/618,436, filed on Jan. 8, 2024.

(51) Int. Cl. G06Q 30/018; H04L 9/00

(52) U.S. Cl. CPC G06Q 30/018; H04L 9/50; G06Q 2220/00

(57) ABSTRACT

A system, and associated devices and methods, capable of linking user of products like seeds or food products to regulatory information or other information associated with specific batches or lots of the product. The system can use a blockchain data network and smart contracts to ensure security and accuracy in the supplied information.

### CROSS-REFERENCES & RELATED APPLICATIONS

This application is a continuation-in-part of U.S. patent application Ser. No. 19/013,823, filed Jan. 8, 2025, and entitled “System and Process for Digital Label and Compliance Authentication,” which claims priority to U.S. Provisional Application No. 63/618,436 filed Jan. 8, 2024, and entitled “System and Process for Digital Label and Compliance Authentication,” both of which are hereby incorporated by reference in their entirety under 35 U.S.C. § 119(e).

### TECHNICAL FIELD

The disclosure relates generally to communication networks, and specifically to communication networks accessible through digital labels.

### BACKGROUND

There is a need in the art for an efficient and convenient way to retrieve information about specific lots of product, such as bags of seed. Currently, identifying information, expiration dates, quality control data, and similar information is printed on bags of seed, as required by the Federal Seed Act. Because some of this information is subject to change or may require updating, physical relabeling of the lots is sometimes necessary. This physical relabeling can be labor intensive, as the individual lots can be difficult to locate or can be inaccessible due to being blocked by other lots of product. A system that allows for the placement of a versatile label that allows for instantaneous and digital updating of supplied information would avoid the difficulties caused by current methods in the art.

### BRIEF SUMMARY OF THE INVENTION

This disclosure relates to a system, and related devices and methods, that allows for the retrieval of data specific to a certain label through a secure, decentralized network. The network can use blockchain technology to ensure the proper routing of information within the network and to properly connect users. The data can be retrieved using a web-enabled device that is configured to read a digital label placed on the relevant lots of product by a supplier who configured the digital label to link the device to the relevant data.

A system of one or more computers can be configured to perform particular operations or actions described in the Examples by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

Example 1 relates to a system for securely conveying information comprising: a digital label; a networked device configured to scan the digital label; at least two blockchain nodes, wherein the at least two blockchain nodes in communication with an export compliance engine, wherein the at least two blockchain nodes transfer data to the networked device by completing a smart contract that is identifiable from the digital label, and wherein the export compliance engine ensures compliance with export regulations.

Example 2 relates to Examples 1 and 3-8, wherein the smart contract uses a hash ID to identify itself.

Example 3 relates to Examples 1-2 and 4-8, wherein the at least two blockchain nodes are further hosted on a virtual private cloud.

Example 4 relates to Examples 1-3 and 5-8, wherein the at least two blockchain nodes are further hosted on at least two elastic computing clouds.

Example 5 relates to Examples 1-4 and 6-8, further comprising a domain name system configured to facilitate communication between the elastic computing clouds.

Example 6 relates to Examples 1-5 and 7-8, wherein the communication between the elastic computing clouds is in the form of application programming interface requests.

Example 7 relates to Examples 1-6 and 8, wherein the data is displayed on the device through a user interface.

Example 8 relates to Examples 1-7, wherein the user interface is hosted on an elastic computing cloud.

Example 9 relates to a system of retrieving data comprising: a first elastic computing cloud instance that hosts a user interface; one or more second elastic computing cloud instances that host one or more blockchain nodes; and a third elastic computing cloud instance that hosts a domain name system configured to facilitate communication between the first elastic computing cloud and the one or more second elastic computing clouds; and one or more smart contracts, with each smart contract associated with one of the one or more blockchain nodes, wherein the one or more smart contracts provides access to data through the user interface.

Example 10 relates to Examples 9 and 11-17, further comprising a device that can access and display the user interface.

Example 11 relates to Examples 9-10 and 12-17, further comprising an application programming interface gateway configured to manage traffic in the system, manage authorization and access control in the system, and API version management in the system.

Example 12 relates to Examples 9-11 and 13-17, wherein the application programming interface gateway is hosted on the third elastic computing cloud instance.

Example 13 relates to Examples 9-12 and 14-17, further comprising an elastic load balancer configured to automatically distribute incoming application traffic among the first elastic computing cloud instance, the one or more second elastic computing cloud instances, and the third elastic computing cloud instance.

Example 14 relates to Examples 9-13 and 15-17, wherein the elastic load balancer is hosted on the third elastic computing cloud instance.

Example 15 relates to Examples 9-14 and 16-17, further comprising a simple storage service hosted in a fourth elastic computing cloud instance configured to store data.

Example 16 relates to Examples 9-15 and 17, further comprising a relational database service hosted in a fifth elastic computing cloud instance configured to manage relational data.

Example 17 relates to Examples 9-16, wherein the relational data is user account data.

Example 18 relates to a method of transferring data comprising: scanning a digital label with a device associated with a purchaser account; associating the digital label with a hash ID that is associated with a smart contract; and linking the device associated with a purchaser account to data uploaded by a supplier through a blockchain data network.

Example 19 relates to Examples 18 and 20, wherein the blockchain data network is made of a plurality of blockchain nodes.

Example 20 relates to Examples 18-19, wherein associating the digital label with a hash ID that is associated with a smart contract automatically completes the smart contract.

Other embodiments of these Examples include corresponding computer systems, apparatus, and computer programs recorded on one or more computer storage devices, each configured to perform the actions of the methods.

### BRIEF DESCRIPTION OF DRAWINGS

FIG. 1A is a diagram of the system as used by a purchaser, according to one implementation.

FIG. 1B is a diagram of the system as used by a supplier producing digital labels, according to one implementation.

FIG. 2A is a diagram of the system with various digital components shown, according to one implementation.

FIG. 2B is a diagram of the system connecting a purchaser to a supplier through the blockchain data network, according to one implementation.

FIG. 3 is a diagram of the communication path through the system connecting a purchaser to a supplier, according to one implementation.

FIG. 4A is a flowchart of a supplier uploading data to the system, according to one implementation.

FIG. 4B is a flowchart of a supplier making digital label using the system, according to one implementation.

FIG. 4C is a flowchart of a purchaser retrieving data from the system, according to one implementation.

FIG. 5 is a flowchart of the system processing API requests from users, according to one implementation.

FIG. 6 is a diagram of the system with an integrated compliance engine, according to one implementation.

FIG. 7 is a diagram of the system with an integrated export compliance engine, according to one implementation.

FIG. 8 is a flowchart of a method of operation of the export compliance engine, according to one implementation.

FIG. 9 shows an exemplary export permit, according to one implementation.

### DETAILED DESCRIPTION

Broadly, implementations of the technology in this disclosure provide systems, devices, and methods that eliminate the need to physically reapply labels to product packaging. In various implementations, the system includes a digital link in a label. The link connects a computing device of a user to a remote server. The link retrieves up-to-date product analysis data that is tracked for the package the label is attached to. The label and link provide verifiable information as the product status changes creating a transparent system.

This system, with associated devices and methods, can have particular usefulness regarding the retrieval of information, such as quality control test data, certificates of assurance, manufacturing dates, and similar information, that is associated with a particular package of material. The Federal Seed Act, as well as other legislation, such as the Food Safety Modernization Act, require packages of material, often called batches or lots, to follow strict labeling procedures to ensure users of the material are informed on material quality. This system provides a streamlined way of providing the same information with reduced effort and reduced opportunity for error. Of course, other uses and applications of the system are possible.

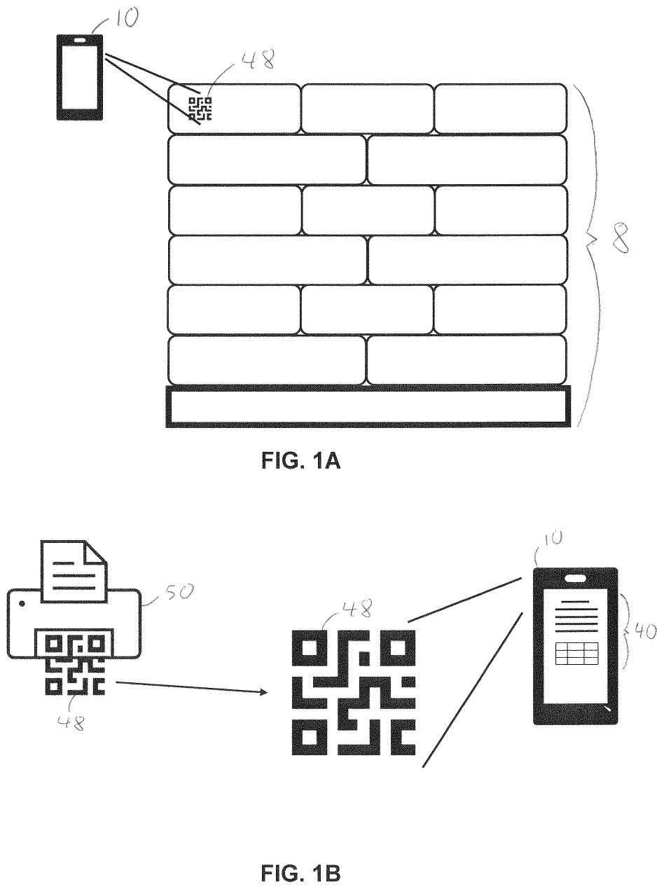

FIGS. 1A and 1B show an implementation of the system 100 where a user can retrieve data 40 (discussed in detail below) for a batch/lot 8 of product using a device 10 such as but not limited to a smartphone, tablet, or scanner, can access a user interface (“UI”) 12.

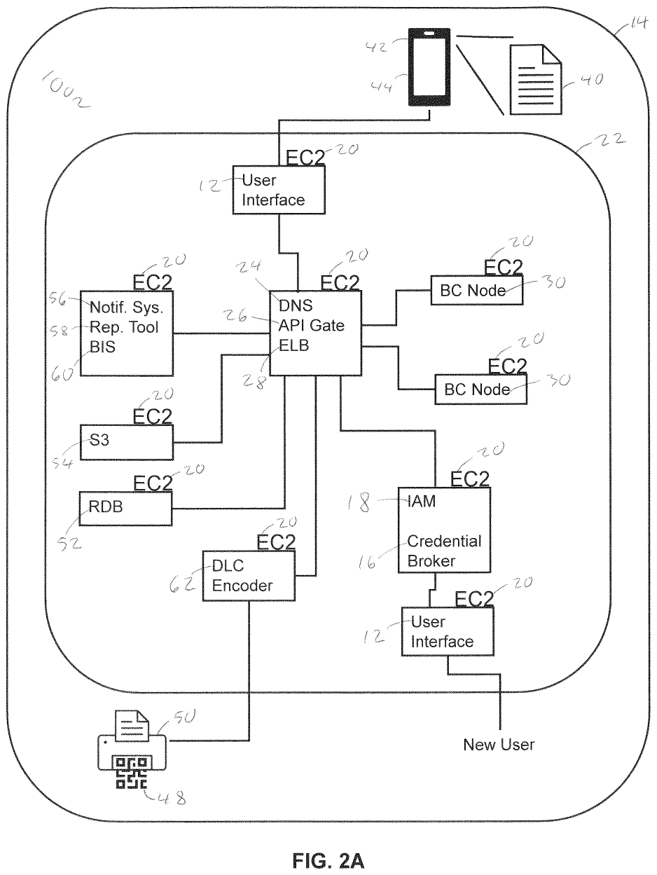

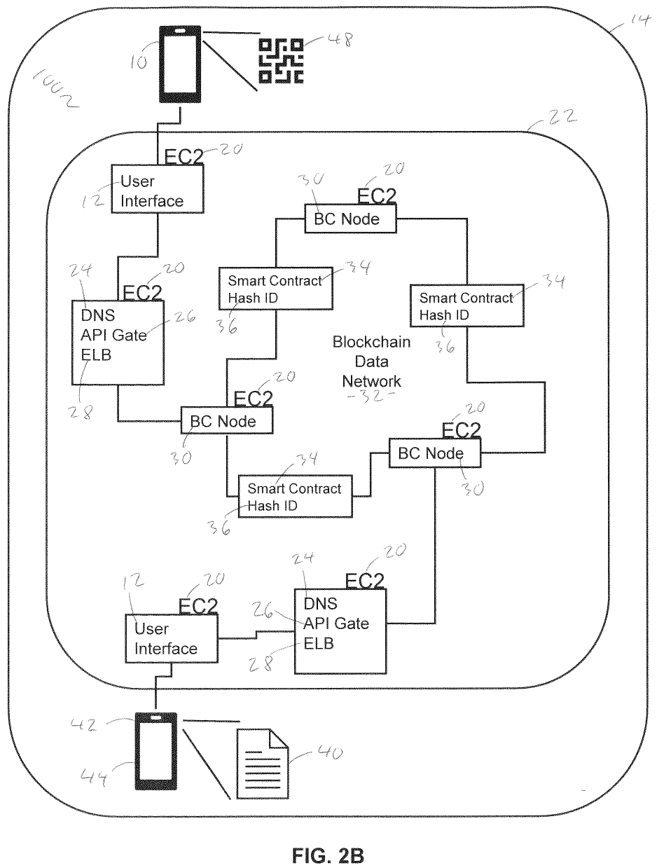

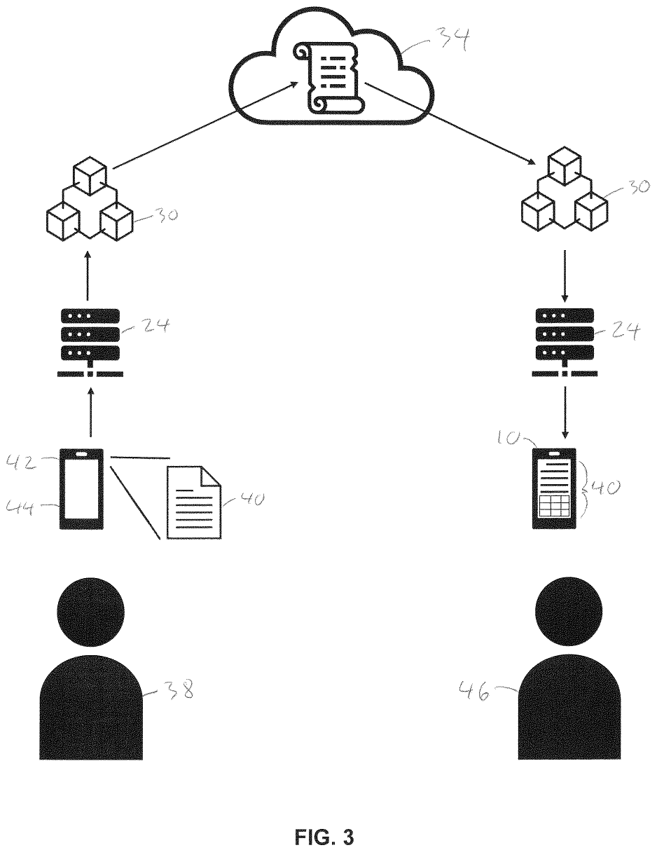

Turning to FIG. 2A, in various implementations, the device 10 is a web-enabled or networked device 10 in that it can connect to the internet 14. Optionally, the networked device 10 connects to the internet 14 wirelessly, such as through a Wi-Fi connection to an internet 14 connected network or a cellular connection to an internet 14 connected cellular network. Of course, other wireless technologies, as well as wired internet 14 connections to the networked device 10 are possible.

The device 10 may gain secure access to the UI 12 by establishing ownership, accreditation, and accessibility permissions through a third party credential broker 16 and an identity and access management (“IAM”) system 18. The credential broker 16 allows users to make and register accounts for the system 100, optionally using a website or mobile app. The IAM system 18 according to these implementations is configured to identify users of different access levels and assign access accordingly. In various implementations, the IAM system 18 is configured to recognize devices 10 and accounts belonging to users such as regulatory bodies, laboratory personnel, producers, manufacturers, and supply chain operators, who may each be given different levels of access to the system 100.

Still in FIG. 2A, instances of the UI 12, credential broker 16, and IAM system 18 may be hosted in one or more elastic computing clouds (“EC2”) 20 or similar storage systems. In various implementations, an EC2 20 may be a cloud-hosted virtual computer that allows for scalable computing capacity within the system 100. Several EC2s 20 can be used within the system 100 for various tasks and functions, as will be discussed below. Each individual EC2 20 may be referred to as an instance.

In various implementations, the EC2s 20 are hosted on a virtual private cloud (“VPC”) 22. In some implementations, the VPC 22 is a cloud-hosted, virtual network that provides a secure connection between the various components of the system 100. The security groups and network access control lists of the VPC 22 may serve as virtual firewalls, controlling inbound and outbound traffic.

Within the VPC 22, according to various implementations, may be more EC2s 20 that host a scalable could domain name system (“DNS”) web service 24.

Communication traffic through the system 100 is managed by the DNS web service 24. Optionally, the EC2s 20 host an application programming interface (“API”) gateway 26 that may oversee all tasks involved in accepting and processing API calls, including traffic management, authorization and access control, monitoring, and API version management. In various implementations, the EC2s 20 also have an elastic load balancer (“ELB”) 28 that automatically distributes incoming application traffic across multiple targets, such as the implemented EC2 20 instances ensuring the system 100 manages the load during high-traffic periods and provides fault tolerance in case instances are unavailable.

Turning briefly to FIG. 2B, in various implementations, users may be assigned a discrete internet-based blockchain node 30 at registration. The blockchain nodes 30 link users to the blockchain data network 32. The blockchain nodes 30 may be hosted within the EC2s 20. In some implementations, the blockchain data network 32 is the underlying blockchain network consisting of self-executing smart contracts 34. That is, in various implementations, the smart contracts 34 are self-executing contracts that directly encode the terms of the agreement into the rules and conditions for each batch/lot 8 dealt with. In some implementations, the smart contracts 34 are written in a programming language compatible with the Ethereum network and are responsible for overseeing the tracking and verification of each batch/lot 8 from production to sale. Each smart contract 34 has a unique and secure hash ID 36.

Returning to FIG. 2A, and also shown in FIG. 3, in some implementations, users, such as a product supplier 38, may input data 40 into the system 100. The data 40 may be but is not limited to quality information, sell-by dates, and status disclosures. The product supplier 38, in various implementations, may input the data 40 to the system 100 using a manual input device 42 or a scanner 44. The input device 42, in some implementations, may be a keyboard or similar device used to type text characters into the system 100. The scanner 44, in some implementations, may be an optical character recognition scanner or similar device capable of recognizing text and converting the text to digital information. In various implementations, the same tool may offer functionality of both a manual input device 42 and a scanner 44. In these implementations, the data 40 may be input into the system 100 from the manual input device 42 or a scanner 44 via an API request managed by the API gateway 26. In some implementations, the data 40 would be input by a user of the system 100 interested in disseminating the data 40 to other users, such as a supplier 38 providing data 40 to a purchaser 46.

In various implementations, the uploaded data 40 is then incorporated into a smart contract 34, which can be shared between users using the blockchain data network 32. Each smart contract 34 also has a discrete hash ID 36 that allows the various users of system 100 and blockchain data network 32 to validate the accuracy and authenticity of the smart contract 34. As would be understood, the blockchain data network 32 allows for the decentralized validation of accuracy and authenticity due to its use of blockchain technology.

In various implementations, other users, such as a purchaser 46 can access the smart contract 34 containing the relevant data 40 using the blockchain data network 32 in order to display the data 40 on a device 10 used by a purchaser 46.

Returning briefly to FIGS. 1A and 1B, in various implementations, the purchaser 46 can retrieve the data 40 by using a device 10 to scan a digital label 48. The digital label 48, in various implementations, may be any technology that allows for unique digital identification such as but not limited to bar codes (including universal product code, code 39, code 128, and similar bar codes), QR codes, radio-frequency identification (“RFID”) tags, or near-field communication (“NFC”) tags. The digital label 48 may be printed or programmed by a digital label creator 50. In various implementations, the device 10 has a functionality that allows for the reading or recognition of the digital label 48. Examples of technology that would allow this functionality include but are not limited to an optical camera accompanying software to recognize bar codes or QR codes, an RFID reader, or an NFC reader.

In some implementations, when a device 10 scans a digital label 48, the device is directed to a smart contract 34 that corresponds to the digital label 48, as established by the user that input the data 40 corresponding to the same smart contract 34.

Now in FIG. 2A, in various implementations, the relation of the digital label 48 to the correct smart contract 34, according to some implementations, is accomplished using the hash ID 36 of the smart contract 34 and a specific EC2 20 dedicated to relation database service (“RDB”) 52. In various implementations, the RDB 52 may manage relational data, such as but not limited to user account information or text extracted from digital label 48 by the scanner 44. In some implementations, data archives and data relevant to, but not specifically tied to, the blockchain data network 32 reside in an EC2 20 committed to S3 54.

The system 100, in various implementations, has a notification system 56 that exists inside an EC2 20 configured to provide real-time notifications to users via the UI 12. A reporting tool 58, optionally existing within the same EC2 20 as the notification system 56, may provide data insight and consolidation tools.

In various implementations, the data insight and consolidation tools may be capable of data aggregation and consolidation, advanced analytics, customizable dashboards, data visualization, compliance reporting, data export and integration, alerting and notifying integration, performance metrics, and various other tools known in the art.

In some implementations, data aggregation and consolidation can include some or all of the following capabilities: combining data from multiple system sources, merging information across batches, merging information across time periods, merging information across product types, and providing a unified data view.

In some implementations, the advanced analytics can include some or all of the following capabilities: performing statistical analysis on product data, identifying trends and patterns, using machine learning for predictive analysis, and using artificial intelligence for predictive analysis.

In some implementations, customizable dashboards can include some or all of the following capabilities: allowing creating of personalized key performance indicator (KPI) dashboards, offering drag-and-drop customization, and supporting real-time data updates.

In some implementations, the compliance reporting can include some or all of the following capabilities: automatically generating regulatory compliance reports, tracking quality control metrics and test results, and providing audit trials and historical data access.

In some implementations, the data export and integration can include some or all of the following capabilities: allowing export in various file formats (PDF, CSV, etc.), integrating with external business intelligence tools, and supporting API access for data sharing.

In some implementations, the altering and notification integration can include some or all of the following capabilities: triggering alerts based on predefined conditions and sending scheduled reports to stakeholders.

In some implementations, the performance metrics can include some or all of the following capabilities: tracking system performance metrics, monitoring user engagement, and monitoring system usage statistics.

A business intelligence service (“BIS”) 60 may also exist within the same EC2 20 and may be configured to create visualization of the information provided by the reporting tool 58, such as charts, graphs, and tables.

In some implementations, the digital label 48 can be encoded or generated using a digital label code (“DLC”) encoder 62. In these implementations, the information encoding the digital label 48 then may be communicated from the DLC encoder to a DLC creator 50, which makes the digital label 48.

The system 100, in its various implementations, can allow users to track the movement of an individual batch/lot 8 of product throughout the supply chain, verify the authenticity of various batches/lots 8, ensure quality control, and otherwise facility transparent sales and shipment transactions. As would be understood, this would be of special importance in industries such as food and food ingredients, agrifoods and feed, pharmaceuticals, luxury goods, and logistics. The blockchain-based verification system, seen in various implementations, of the system 100 can be adapted to verify the authenticity and origin of various products in addition to providing documentation regarding testing or quality control.

Further, the system 100 may be deployed in the healthcare industry to accurately and efficiently track patient data and healthcare records. The blockchain-based verification system, seen in various implementations, of the system 100 ensures stakeholders can verify the accuracy and authenticity of patient data tracked within the system 100.

The system 100 can find further use in finance, e-commerce, government service, online platforms, and other industries where strong authentication and secure identity management are paramount.

Various implementations of the system 100 also provide the benefit of inherently forming transparent and immutable records for each batch/lot 8 due to the use of blockchain technology. These records, formed within the blockchain for each batch/lot 8 may include a history of the lifecycle of the product, production details of the product, quality reports, verification processes, ownership transfers, and sale records, among various other records. Another benefit of various implementations of the system 100 is the real-time tracking of information related to each batch/lot 8, as the blockchain tracking is decentralized and does not require routing of information through a central system, which could cause delays.

One application of the system 100 is in providing users with information required by the Federal Seed Act. In various implementations, this information can be sell-by dates, testing information, quality assurance and quality control documentation, and similar information. In one example of the benefits of the system 100 is in the case of an expired batch/lot 8 of seed. Under the Federal Seed Act, the expiration of seeds necessitates retesting and physical relabeling of the batch/lot 8. The system 100, through its notification system 56 could provide users, particularly a supplier 38, with a notice that the batch/lot 8 had expired. The supplier 38 could then retest the batch/lot 8 and update the data 40 provided by the smart contract 34 rather than physically relabeling the batch/lot 8.

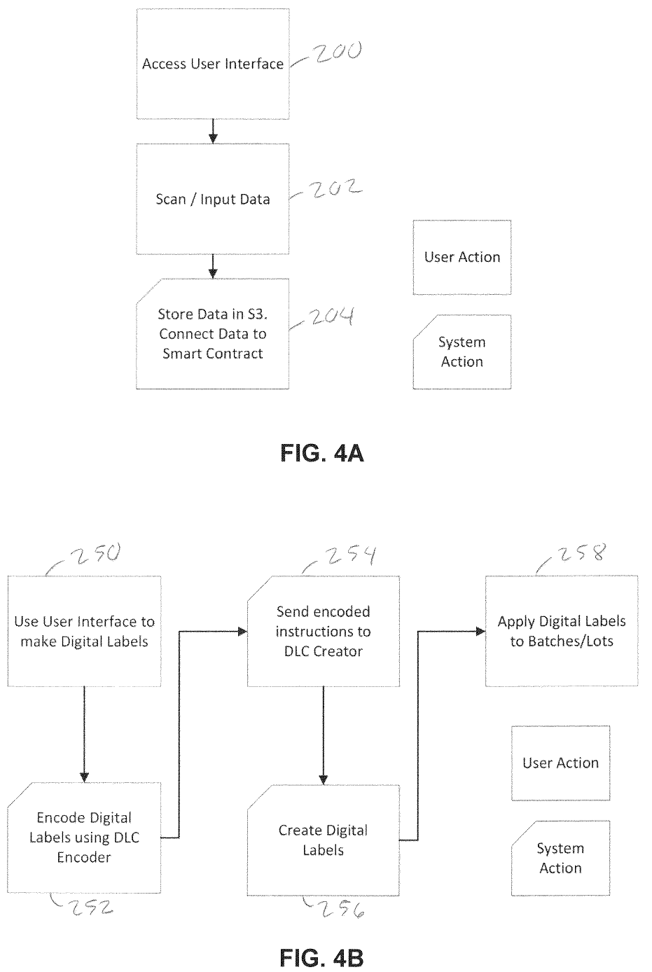

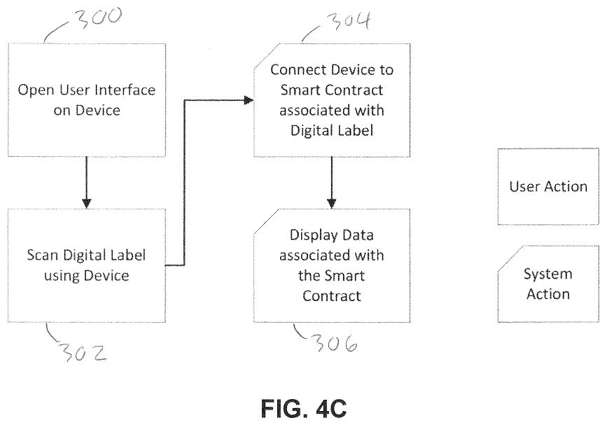

FIG. 4A describes a method of inputting data 40 into the system 100, according to one implementation. Each of these steps is optional, and the steps can be rearranged as might be needed or desired in various other implementations. In various implementations, the method may begin with a user, optionally a supplier 38, accessing the UI 12 (box 200). In some implementations, the UI 12 can be accessed using the manual input device 42 or scanner 44. The user may then optionally input data 40 with the manual input device 42 or scan in data 40 with scanner 44 (box 202). In various implementations, the system 10, will then store the data 40 in a simple storage service (“S3”) 54, which will be discussed in detail below, and connecting that data 40 to a smart contract 34, as discussed above (box 204).

FIG. 4B describes a method of creating digital labels 48, according to one implementation. Each of these steps is optional, and the steps can be rearranged as might be needed or desired in various other implementations. In some implementations, the user may use the UI 12 to initiate the process of making digital labels 48 (box 250). The system 100 may then encode a digital label 48 that is recognizable by the device 10 and is electronically linked to a smart contract 34 (box 252). The encoded information can then be communicated to a DLC creator 50 (box 254), which may then physically create the digital labels 48 (box 256). The user, optionally a supplier 38 may then apply the digital labels 48 to corresponding batches/lots 8 of product (box 258).

FIG. 4C describes a method of retrieving data 40 about a batch/lot 8 of product, according to one implementation. Each of these steps is optional, and the steps can be rearranged as might be needed or desired in various other implementations. A user, such as a purchaser 46 may initiate the process of retrieving the data 40 by accessing the UI 12 on a device 10 (box 300). The user may then scan the digital label 48 attached to the batch/lot 8 with the device 10 (box 302). The system 100 may then connect the device 10 to the smart contract 34 associated with the scanned digital label 48 (box 304). Completion of the relevant smart contract 34 may then allow the system 100 to display the data 40 for the user (box 306).

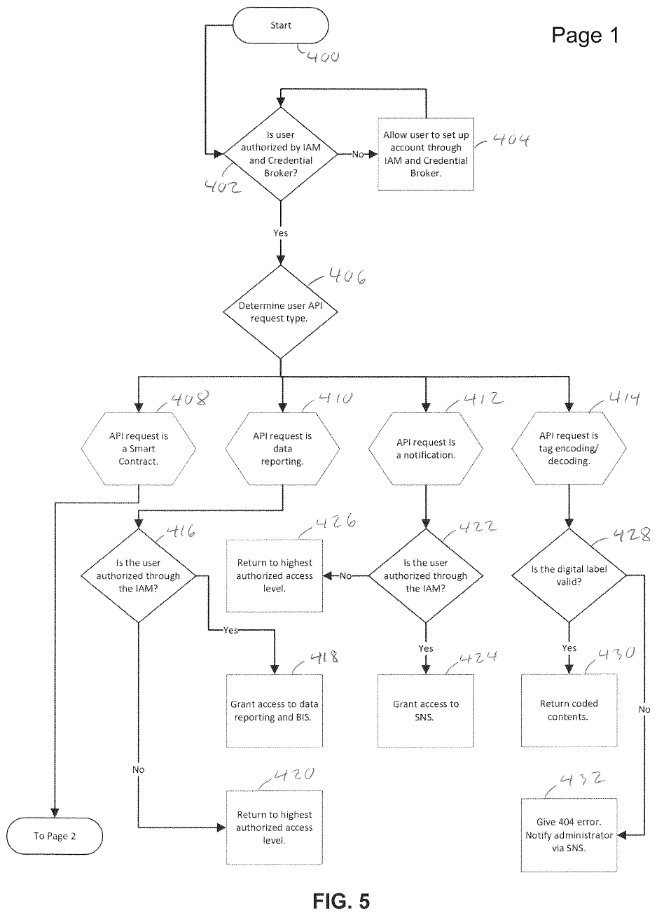

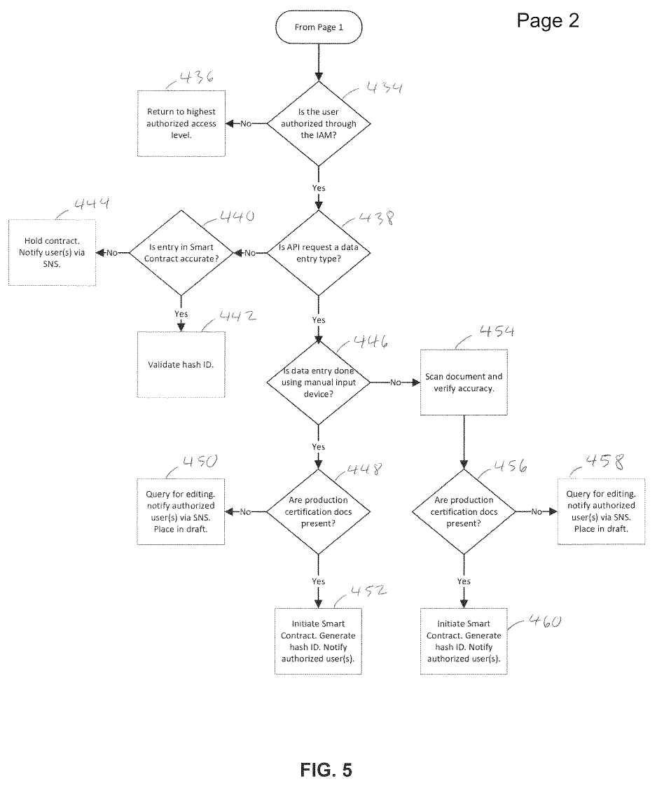

FIG. 5, consisting of two pages, shows a flowchart of one exemplary implementation of operational steps the system 100. Each of these steps is optional, and the steps can be rearranged as might be needed or desired in various other implementations.

When a user accesses the system 100 (box 400), the system 100 may first determine if the user has been previously authorized by the credential broker 16 and IAM system 18 (box 402). If the user has not been previously authorized, the system 100 may allow the user to set up an account and become authorized through the credential broker 16 and IAM system 18 (box 404). If the user has been authorized, the system will then determine which type of API request the user is making (box 406). In this exemplary implementation, four types of API requests are contemplated, but more or less are possible. The system 100 will determine if the API request is a smart contract 34 (box 408), data reporting (box 410), a notification (box 412), or tag encoding/decoding (box 414).

If the API request is data reporting, the system 100 may reaffirm the user is sufficiently authorized through the IAM system 18 (box 416). If the user is sufficiently authorized, the system 100 may grant access to the reporting tool 58 and the BIS 60 (box 418). If the user is not sufficiently authorized, the user may be returned to the highest access level of the UI 12 for which the use is authorized (box 420).

If the API request is a notification, the system 100 may reaffirm the user is sufficiently authorized through the IAM system 18 (box 422). If the user is sufficiently authorized, the system 100 may grant access to the SNS 54 (box 424). If the user is not sufficiently authorized, the user may be returned to the highest access level of the UI 12 for which the user is authorized (box 426).

If the API request is for tag encoding or decoding, the system 100 may determine if the digital label 48 is valid (box 428). In various implementations, the validity of the digital label 48 can be determined by matching a unique hash ID 36 associated with a digital label 48 with a unique hash ID 36 associated with a smart contract 34, as will be discussed in detail below. As would be understood, hash IDs 36 that employ blockchain technology provide inherent security in connecting end users in this way due to the large amount of computational work required to generate a hash ID 36, meaning a hash ID 36 with the most computational work shown can safely be determined to be authentic. If the digital label 48 is determined to be valid, the coded contents may be returned to the user either encoded or decoded (box 430). If the digital label 48 is determined not to be valid, the user may be shown an error message, and a system 100 administrator may be notified via the SNS 54 (box 432).

If the API request is for a smart contract, the system 100 may reaffirm the user is sufficiently authorized through the IAM system 18 (box 434). If the user is not sufficiently authorized, the user may be returned to the highest access level of the UI 12 for which the user is authorized (box 436). If the user is sufficiently authorized, the system 100 may then determine whether the API request is a data entry type API request (box 438). If the API request is not a data entry type, the system 100 may determine if the entered smart contract 34 is accurate (box 440). If the smart contract 34 is accurate, the system 100 may validate the hash ID 36 associated with the smart contract 34 (box 442). If the smart contract 34 is not accurate, the system 100 is not accurate, the system 100 may hold the smart contract 34 and notify the user with the SNS 54 (box 444).

If the API request is a data entry type, the system 100 may determine if the data entry was done using a manual input device 42 or a scanner 44 (box 446). If the data entry was done using a manual input device 42, the system 100 may determine if the production certification documents are present (box 448). If the production certification documents are not present, the system 100 may send the user a query to edit the API request and place the API request in draft status (box 450). If the production certification documents are present, the system 100 may initiate the smart contract 34, generate a hash ID 36, and notify authorized users (box 452).

If the data entry was done using a scanner 44, the system 100 may scan in the document and verify document accuracy (box 454). The system 100 then may determine if the production certification documents are present (box 456). If the production certification documents are not present, the system 100 may send the user a query to edit the API request and place the API request in draft status (box 458). If the production certification documents are present, the system 100 may initiate the smart contract 34, generate a hash ID 36, and notify authorized users (box 460).

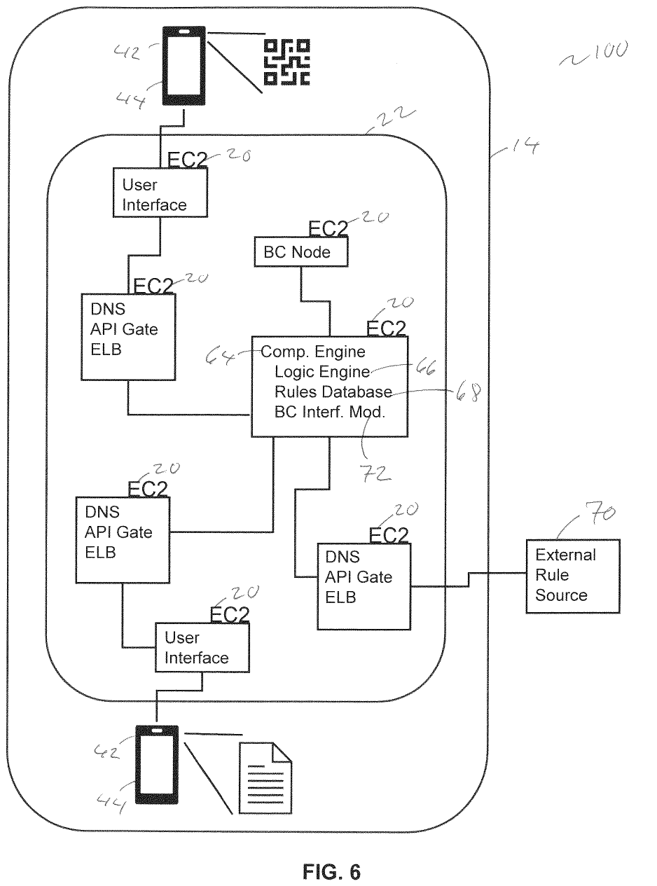

Turning now to FIG. 6, in some embodiments, the system 100 may have a compliance engine 64, that may evaluate whether various batches/lots 8 comply with regulations that may be relevant for the various batches/lots 8. The compliance engine 64 may be hosted in an EC2 20 within the VPC 22.

The compliance engine 64 may, in various implementations, may have a logic engine 66 and a rules database 68. In various implementations, the logic engine 66 may be an algorithm or program constructed to compare data 40 associated with a particular batch/lot 8 to relevant rules or regulations to ensure compliance. In some implementations, the logic engine 66 may be in communication with a rules database 68 that may store the relevant rules and regulations that may be necessary. In some implementations, the rules database 68 may be hosted in the compliance engine 68. In other implementations, the rules database 68 may be hosted in the S3 54 or other EC2 20 instance.

The compliance engine 64 may be configured to search external rule sources 70 in order to provide the logic engine 66 and rules database 68 with relevant rules and regulations. For instance, the compliance engine 64 may receive an inquiry from a purchaser 46 regarding a specific product. A supplier 38 may have the product, but in a different jurisdiction. The compliance engine 64 may review the relevant rules and regulations of both the jurisdiction in which the purchase 46 resides and in which the supplier 38 resides. If the rules and regulations of both jurisdictions are satisfied, the compliance engineer 64 may label the relevant batches/lots 8 as compliant. If one or more rule or regulation is not satisfied, the compliance engineer 64 may label the relevant batches/lots 8 as non-compliant.

Still in FIG. 6, in some implementations, the compliance engine 64 may generate various other determinations based on the particular rule or regulation that may be found to be violated. For instance, the compliance engine 64 may generate a determination of “expired” if a batch/lot 8 is found to be older than an expiration date, either determined by supplier 38 standards or by standards established by regulatory bodies. The compliance engine 64 may likewise generate a determination of “retest required” if a batch/lot 8 is found to be older than an expiration date, but that expiration date may be extended by retesting the material, such as by resubmitting the material to quality control tests. The compliance engine 64 may generate a determination of “label update required” if a batch/lot 8 is found to have out of date or incorrect information on its label. The compliance engine 64 may generate a determination of “certificate invalid” if a certificate of analysis corresponding to the batch/lot 8 is found to be incorrect or unacceptable. As would be understood, various other determinations may be made by the compliance engine 64 from various findings relating to the batch/lot 8.

In various implementations, the determination of the compliance engine 64 may be converted into a compliance event, which may be a record of a particular inquiry regarding a batch/lot 8 and the corresponding compliance state. The information included in a compliance event may vary, but in various implementations, it may include the event type (expired, retest required, etc.), a timestamp, a jurisdiction identifier, a rule citation, a batch/lot 8 identifier, the relevant smart contract hash ID 36, and relevant test data references.

The compliance engine 64 may have a blockchain interface module 72 that may communicate with various blockchain nodes 30 and the blockchain data network 32 more broadly. The compliance engine 64 may store each compliance event on a blockchain node 30, thereby ensuring the compliance event will remain unaltered and verifiable.

In various implementations, the compliance events may be automatically reported to relevant governing bodies as may be necessary. In such implementations, the system 100 may use an API gateway 26 to send the compliance events to the required governing or regulatory bodies. In various implementations, these compliance events may be authenticated using the credential broker 16 and IAM system 18.

In various other implementations, the system 100 may use an API gateway 26 to monitor for updates to rules and regulations. In such implementations, the API gateway 26 may intake updated rules and regulations and supply them to the compliance engine 64, which may update its logic to follow the updated rules and regulations. In various implementations, the authenticity of updated rules and regulations may be verified through the use of cryptographic signatures associated with each update.

In various implementations, the relevant regulatory bodies may access the compliance events for inspection, auditing, and enforcement, and the regulatory bodies may be assured of their authenticity due to the use of blockchain authentication.

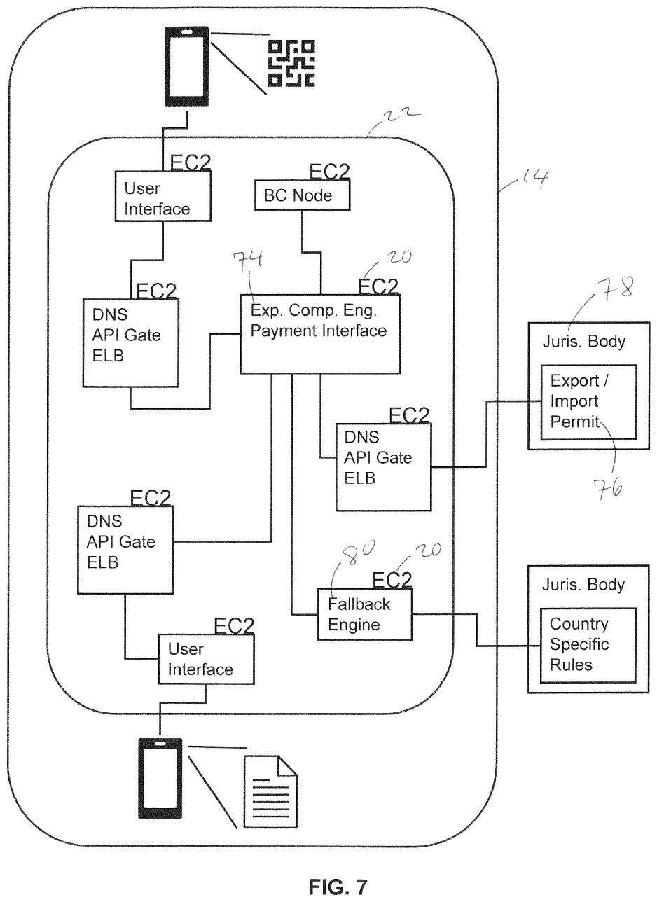

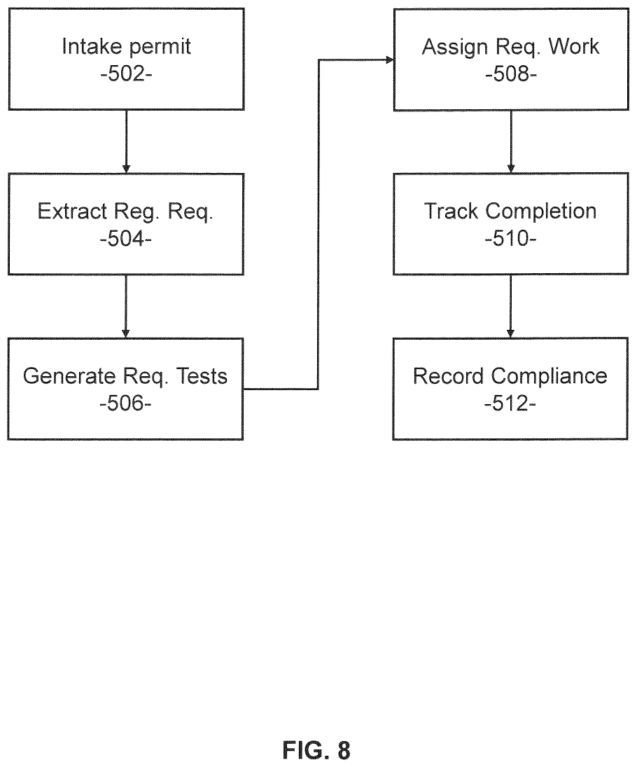

Turning now to FIGS. 7 and 8, various implementations of the system 100 may have an export compliance engine 74 that may manage the import and/or export permits required for various batches/lots 8. As would be understood, the user responsible for managing regulator compliance is often the product supplier 38, who would most often be exporting a batch/lot 8, however, the export compliance engine 74 system 100 may also accommodate import compliance tasks. In various implementations, the export compliance engine 74 may integrate the needed import and/or export permits into relevant smart contracts 34.

FIG. 7 shows a conceptual diagram of its potential structure, while FIG. 8 describes a method of operation 500 of the export compliance engine 74. The particular structure shown in FIG. 7 is illustrative and is not the only structure which the system 100 and export compliance engine 74 may take. Similarly, the method of operation 500 described in FIG. 8 is merely illustrative. The steps described in FIG. 8 may be recorded, omitted, or modified as required, and other steps may be performed alongside the ones described.

Now in FIG. 8, in various implementations, the export compliance engine 74 may receive or retrieve an export permit 76 or import permit 76 from a relevant jurisdictional body 78 (box 502). The export permits 76 or import permits 76 may be a taken from a variety of sources, such as but not limited to US Department of Agriculture (USDA) Animal and Plant Health Inspection Service (APHIS) Phytosanitary requirements, APHIS export permits for regulated seeds, Plant Variety Protection Act requirements, and Federal Insecticide, Fungicide, and Rodenticide Act (FIFRA) requirements. These export permits 76 or import permits 76 may be those published or passed by various jurisdictional bodies 78, such as but not limited to the USDA, US Customs and Border Protection, the US Environmental Protection Agency, the International Plant Protection Convention, and the European Commission Directorate-General for Health and Food Safety.

In various implementations, the export permits 76 or import permits 76 may be received or retrieved through an API gateway 26. In similar implementations, the export permits 76 or import permits 76 may be authenticated using the credential broker 16 and IAM system 18.

In various implementations, there may not be a relevant export permit 76 or import permit 76 published by the relevant jurisdictional body 78. In such implementations, the system 100 may have a fallback engine 80 that may reference country-specific export or import rules 82. In various implementations, these country-specific export or import rules 82 may be maintained, such as in a database, by the National Plant Protection Organization (NPPO) for a country, such as but not limited to the USDA APHIS Export Manuals.

In various implementations, after intaking an export permit 76, import permit 76, or country-specific export or import rules 82, the export compliance engine 74 may extract the various discrete regulatory requirements described or listed in the export permit 76, import permit 76, or country-specific export or import rules 82 (box 504).

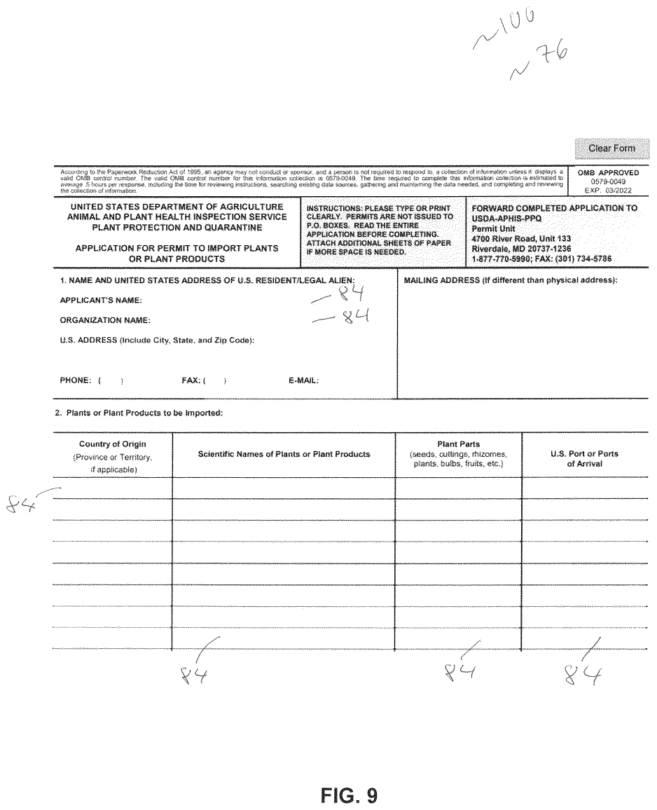

Once the discrete regulatory requirements are extracted, the export compliance engine 74 may generate one or more compliance slots 84 (box 506). The compliance slots 84 may correspond to a discrete requirement of the export permit 76, export permit 76, or country-specific export or import rules. In some implementations, the compliance slots 84 may be used to record or present information such as but not limited to the requirement type, the assigned verifier, the due date based on desired shipment schedule, the expected document type, the regulatory citation, and the blockchain event linkage. FIG. 9 shows an example of an export permit 76 containing numerous unfilled compliance slots 84.

Returning to FIGS. 7 and 8, the export compliance engine 74 may then either fill each generated compliance slot 84 with the required information or may create prompts for various technicians or inspectors to provide the required information. The export compliance engine 74 may fill the compliance slot 84 with data stored throughout the system 100, such as in the S3 54. The export compliance engine 74 may produce prompts when such information is not stored within the system 100, and such prompts may be issued to people or organizations that may be able to supply the required information. These people or organizations that may be given prompts may include various laboratories, fumigation providers, USDA/APHIS inspectors, certification officers, internal quality control personnel, internal quality assurance personnel, and various others.

In various implementations, as a part of generating the issued prompts, the system 100 may generate various work orders that include deadlines, instructions, sample numbers, and required reporting formats that may be necessary or convenient.

As compliance slots 84 are filled with the required documents or information, the system 100 may assign hash ID 36 to each document or portion of information to allow for the authentication of the document or information with blockchain technology.

Once the compliance slots 84 are filled and authenticated with blockchain technology, the export compliance engine 74 and system 100 may automatically integrate the information contained in the export permit 76, import permit 76, or country-specific export or import rules 82 into a smart contract 34, which may be accepted by a purchaser 46 or other user of the system 100. In various implementations, the smart contract 34 may have information relating to shipment details, batch/lot 8 identifiers, the various relevant compliance slots 84 with relevant information, relevant deadlines, payment terms, and other relevant information.

The export compliance engine 74 may have various other components that may assist in the creation and execution of smart contracts 34. In some implementations, the export compliance engine 74 may have a payment interface 86 that may be configured to facilitate payments required for smart contracts 34. The payment interface 86 may allow for the use of a variety of payment methods, such as tokenized payment rails, secure ACH, digital letter-of-credit equivalents, or other similar payment technologies. In some implementations, the payment may be taken by the payment interface 86 but not released to the supplier 38 until all export compliance requirements, such as those captured in an export permit 76, are satisfied and verified through the blockchain.

Although the disclosure has been described with reference to preferred implementations, persons skilled in the art will recognize that changes may be made in form and detail without departing from the spirit and scope of the disclosed apparatus, systems, and methods.

What is claimed is:

1. A system for securely conveying information comprising:
a) a digital label;
b) a networked device configured to scan the digital label;
c) at least two blockchain nodes in communication with an export compliance engine,
wherein the at least two blockchain nodes transfer data to the networked device by completing a smart contract that is identifiable from the digital label, and
wherein the export compliance engine ensures compliance with export regulations.

2. The system of claim 1, wherein the smart contract uses a hash ID to identify itself.

3. The system of claim 1, wherein the at least two blockchain nodes are further hosted on a virtual private cloud.

4. The system of claim 3, wherein the at least two blockchain nodes are further hosted on at least two elastic computing clouds.

5. The system of claim 4, further comprising a domain name system configured to facilitate communication between the elastic computing clouds.

6. The system of claim 5, wherein the communication between the elastic computing clouds is made via of application programming interface requests.

7. The system of claim 1, wherein the data is displayed on the device through a user interface.

8. The system of claim 7, wherein the user interface is hosted on an elastic computing cloud.

9. A system of retrieving data comprising:
a) a first elastic computing cloud instance that hosts a user interface;
b) one or more second elastic computing cloud instances that host one or more blockchain nodes;
c) a third elastic computing cloud instance that hosts a domain name system configured to facilitate communication between the first elastic computing cloud and the one or more second elastic computing clouds; and
d) one or more smart contracts, with each smart contract associated with one of the one or more blockchain nodes,
wherein the one or more smart contracts provides access to data through the user interface.

10. The system of claim 9, further comprising a device that can access and display the user interface.

11. The system of claim 9, further comprising an application programming interface gateway configured to manage traffic in the system, manage authorization and access control in the system, and application programming interface version management in the system.

12. The system of claim 11, wherein the application programming interface gateway is hosted on the third elastic computing cloud instance.

13. The system of claim 9, further comprising an elastic load balancer configured to automatically distribute incoming application traffic among the first elastic computing cloud instance, the one or more second elastic computing cloud instances, and the third elastic computing cloud instance.

14. The system of claim 13, wherein the elastic load balancer is hosted on the third elastic computing cloud instance.

15. The system of claim 9, further comprising a simple storage service hosted in a fourth elastic computing cloud instance configured to store data.

16. The system of claim 9, further comprising a relational database service hosted in a fifth elastic computing cloud instance configured to manage relational data.

17. The system of claim 16, wherein the relational data is user account data.

18. A method of transferring data comprising:
scanning a digital label with a device associated with a purchaser account;
associating the digital label with a hash ID that is associated with a smart contract; and
linking the device associated with a purchaser account to data uploaded by a supplier through a blockchain data network.

19. The method of claim 18, wherein the blockchain data network is made of a plurality of blockchain nodes.

20. The method of claim 18, wherein associating the digital label with a hash ID that is associated with a smart contract automatically completes the smart contract.
